(19) United States
(12) Patent Application Publication
(10) Pub. No.: US 2012/0158767 A1
(43) Pub. Date: Jun. 21, 2012

(54) Providing Package Products

(75) Inventors: Martin J. Drefs, Edina, MN (US); Jefferson Bridger Walsh, Sandy, UT (US); Benjamin Eric Noffsinger, West Valley, UT (US); Lydia Nanette Olchoff, Salt Lake City, UT (US); Sam Jason Coverston, Alpine, UT (US); Christopher Paul Johnston, Salt Lake City, UT (US); Shih-Hao Wang, Midvale, UT (US); Anthony James Gale, Beaver, UT (US); Samuel William Ashworth, Salt Lake City, UT (US)

(73) Assignee: ACCENTURE GLOBAL SERVICES LIMITED, Dublin (IE)

(21) Appl. No.: 12/968,430

(22) Filed: Dec. 15, 2010

(51) Int. Cl. G06F 17/30

(52) U.S. Cl. 707/769; 707/E17.014

(57) ABSTRACT

Package products include slots for component products, price information, and attribute information for selecting component product options for the package products. Information regarding the package products and the component product options is provided to customers for selection of a desired package product and desired component product options. The package products and component products provide flexible control to providers of the package products and to providers of the component products and allow package products to be generated quickly in response to a request from a customer for a package product having desired attributes and meeting desired availability and price criteria.

### TECHNICAL FIELD

This disclosure relates to providing package products.

### BACKGROUND

Providers of goods or services, including resellers and aggregators of goods and services, may offer multiple kinds of goods or services. Some of the multiple goods and services may be compatible and/or combinable such that one or more customers can purchase and use two or more different ones of the multiple goods and services. For example, a seller of a durable product, such as an automobile or a television, can offer a warranty service for the product.

### SUMMARY

Various products and/or services can be combined to form a package product and the package product can be offered for sale as a unit for a single price. For example, travel package components such as an airline flight, a hotel room, a rental car, an activity, an insurance product, and/or a retail product can be combined to form a travel package product that is offered at a unit price. A package product includes slots that define which types of component products are included in the package product. The package product also includes, for each slot, component attributes that define which package components are compatible with the package product. For example, a simple travel package product includes a first slot for an airline flight and a second slot for a hotel room. The slot for the airline flight includes one or more attribute for the airline flight component product, such as an attribute indicating that the flight is a non-stop flight or an attribute that indicates that the seat on the flight is a business class seat. The slot for the hotel room includes one or more attributes for the hotel room component product, such as an attribute that indicates that the hotel has a 4-star rating or an attribute that indicates that the hotel room has an ocean view.

To offer the package product for sale, candidate component products are searched to identify component products that have attributes that match the attributes of a matching type of component slot of a package product. Each component product that matches the type of a component slot of the package product and that matches all of the attributes of the matching component slot is identified as an available component product that can fill the matching component slot of the package product. One of the available component products is selected for each component slot to create the package product. A customer can be presented with an interface to accept the package product and/or to revise the package product, such as by changing one or more of the selected package components for others of the available package components.

In one general aspect, a method of providing package products is disclosed. The method includes receiving a request for one or more package products, wherein the one or more package products includes package components, and the request includes information regarding types of package components to be included in the one or more package products and availability information. The method also includes accessing information regarding candidate package products, wherein each candidate package product includes package slots for a type of package component, identifying, by at least one computer processor, available package products from among the candidate package products based on the package products having package component slots for package components of the types included in the request, and selecting a package product from among the identified package products, and accessing information regarding candidate package components. The method also includes identifying, by at least one computer processor, available package components from among the candidate package components, wherein the available package components have package component types that match the package component types of the package component slots of the selected package product and have availability information compatible with the availability information of the request, and associating the available package components with the identified package products. The available package components are associated with the identified package products based on a match between the package component types of the available package components and the selected package product. The method also includes providing information regarding the selected package product and the available package components in response to the request for a package product.

Implementations can include one or more of the following features. For example, the types of package components to be include in the product package may include at least one of an airline flight, a hotel room, a rental car, an activity, an insurance product, and a retail product. The package components may include price information. The selected package product may include pricing information regarding how a price of an available package product is to be generated based on the price information of the package components associated with the candidate package product. The pricing information may include at least one of fixed pricing information and dependent pricing information, the fixed pricing information being used to select available package components to be associated with the candidate package product and the dependent pricing information being used to adjust the price information of the available package products associated with the candidate package product. The available package components may be associated with the identified package products based on package generation rules associated with the available package products. Two or more of the available package products may be selected and information regarding the two or more selected package products may be provided in an order determined according to one or more ranking rules that are applied to each of the available package products.

In another general aspect, a system includes a receiver that receives a request for one or more package products, wherein the one or more package products includes package components, and wherein the request includes information regarding types of package components to be included in the one or more package products and availability information. The system also includes one or more storage devices that store information regarding candidate package products, wherein each candidate package product includes package slots for a type of package component. The system also includes one or more computer processors that identify available package products from among the candidate package products based on the package products having package component slots for package components of the types included in the request, select a package product from among the identified package products, and identify available package components. The available package components have package component types that match the package component types of the package component slots of the selected package product and have availability information compatible with the availability information of the request. The one or more computer processors also associate the available package components with the selected package product, wherein the available package components are associated with the identified package products based on a match between the package component types of the available package components and the selected package product.

Implementations can include one or more of the following features. For example, the types of package components to be include in the product package may include at least one of an airline flight, a hotel room, a rental car, an activity, an insurance product, and a retail product. The package components include price information. The selected package product may include pricing information regarding how a price of an available package product is to be generated based on the price information of the package components associated with the candidate package product. The pricing information may include at least one of fixed pricing information and dependent pricing information, the fixed pricing information being used to select available package components to be associated with the candidate package product and the dependent pricing information being used to adjust the price information of the available package products associated with the candidate package product. The available package components may be associated with the identified package products based on package generation rules associated with the available package products. Two or more of the available package products may be selected and information regarding the two or more selected package products may be provided in an order determined according to one or more ranking rules that are applied to each of the available package products.

In another general aspect, a tangible computer-readable storage medium has a computer program product stored thereon. The computer program product includes instructions that, when executed by one or more computer processors, enable receiving a request for one or more package products, wherein the one or more package products includes package components, and wherein the request includes information regarding types of package components to be included in the one or more package products and availability information. The instructions also enable accessing information regarding candidate package products, wherein each candidate package product includes package slots for a type of package component, identifying, by at least one computer processor, available package products from among the candidate package products based on the package products having package component slots for package components of the types included in the request, selecting a package product from among the identified package products, and accessing information regarding candidate package components. The instructions also enable identifying, by at least one computer processor, available package components from among the candidate package components, wherein the available package components have package component types that match the package component types of the package component slots of the selected package product and have availability information compatible with the availability information of the request. The instructions also enable associating the available package components with the identified package products, wherein the available package components are associated with the identified package products based on a match between the package component types of the available package components and the selected package product, and providing information regarding the selected package product and the available package components in response to the request for a package product.

Implementations can include one or more of the following features. For example, the types of package components to be include in the product package may include at least one of an airline flight, a hotel room, a rental car, an activity, an insurance product, and a retail product. The package components may include price information. The selected package product may include pricing information regarding how a price of an available package product is to be generated based on the price information of the package components associated with the candidate package product. The pricing information may include at least one of fixed pricing information and dependent pricing information. The fixed pricing information may be used to select available package components to be associated with the candidate package product and the dependent pricing information may be used to adjust the price information of the available package products associated with the candidate package product. The available package components may be associated with the identified package products based on package generation rules associated with the available package products. Two or more of the available package products may be selected and information regarding the selected package products may be provided in an order determined according to one or more ranking rules that are applied to each of the available package products.

The details of one or more implementations are set forth in the accompanying drawings and the description below. Other features will be apparent from the description and drawings, and from the claims.

### DESCRIPTION OF DRAWINGS

FIG. 1 is a diagram of a system for providing package products.

FIG. 2 is a diagram of a process for providing package products.

FIG. 3 is a diagram of a system for providing package products.

FIG. 4 is a diagram of a data structure including information regarding a package product.

FIG. 5 is a diagram of a data structure including information regarding a package component.

FIG. 6 is a diagram of a process for providing package products.

FIG. 7 is a diagram of a computer system.

FIG. 8 is a diagram of a graphical user interface for requesting a package product.

FIG. 9 is a diagram of a graphical user interface for selecting a package product.

FIG. 10 is a diagram of graphical user interface for changing component products of a selected package product.

Like reference symbols in the various drawings indicate like elements.

### DETAILED DESCRIPTION

Referring to FIG. 1, a system 100 for providing package products includes a package engine 110 that receives a package request 101 and provides package information 109 regarding package products that meet criteria included in the package request 101. The system 100 also includes a package product information repository 120 that stores information regarding candidate package products, component product information repositories 131 and 135 that store information regarding candidate component products, and a packaging rule information repository 140 that stores information regarding one or more packaging rules. The package engine 110 is operable to access the information stored on the package product information repository 120, on the component product information repositories 131 and 135, and on the packaging rule information repository 140. For candidate package products, such as for each package product included in the system 100, the package product information repository 120 includes information regarding component product types and required component product attributes for two or more component slots. The component product information repositories 131 and 135 include, for each component product, information regarding a component product type and attributes of the component product. For example, the component product information repository 131 can include information regarding products associated with a first provider, and the component product information repository 135 can include information regarding products associated with a second provider. The packaging rule information repository 140 includes information regarding how the package engine 110 is to produce the package information 109 for output using the information regarding candidate package products and the information regarding candidate component products.

In use, as illustrated in FIG. 2, the system 100 can be used according to a process 200 for providing package products. In the process 200, when the package engine 110 receives the request 101 for one or more package products (201), the package engine 110 accesses information regarding candidate package products (203). For example, the request 101 includes information regarding types of component products to be included in the one or more package products, such as an airline flight and a hotel room reservation, and availability information, such as a preferred or required time and/or date of departure or return and a destination location.

The package engine 110 identifies package products that have slots for component products of the types indicated by the information included in the request 101 (205). For example, if the information included in the request 101 indicates that a package product including an airline flight and a hotel room is desired, the package engine 110 identifies as available package products all of the candidate package products that have component slots for airline flights and for hotel rooms. In other examples, the package engine 110 identifies as available package products only the candidate package products that have only component slots for airline flights and for hotel rooms, or the package engine 110 identifies as an available package product any package product that includes a component slot for an airline flight or for a hotel room. In some implementations, identifying the available package products involves querying one or more internal sources of package product information and/or one or more external sources of package product information. For example, an operator of the package engine 110 can maintain an internal repository of package product information, while one or more providers of component products or other entities can also maintain repositories of package product information.

After identifying available package products, the package engine 110 selects a package product (207). For example, the package engine 110 ranks the available package products according to one or more packaging rules, such as a packaging rule that causes the package engine 110 to rank the available package products according to a price or profitability of the package products and selects the highest ranked package product. Additionally or alternatively, the package engine 110 can rank the available package products according to a customer rating of the package products, historical performance of the package products, a measure of similarity of the package products to the package request, or another parameter of the package products. Similarly, other factors can be considered in selecting an available package product, such as a preference setting of a customer that generated the package request 101, or other filters.

The package engine 110 also accesses information regarding candidate package component products (209). For example, the package engine 110 can access the component product information repositories 131 and/or 135. After accessing the information regarding the candidate package component products, the package engine 110 identifies available component products from among the candidate package component products (211). For example, the package engine 110 can identify as available component products any of the component products that have availability information, such as time and/or date information and location information, that is compatible with availability information included in package request 101. In some implementations, the package engine can perform a real-time check of the availability of the component products. Additionally or alternatively, the available component products can be selected based on other types of availability information, such as a minimum quality or quantity of the component product, a desired feature of the component product, or another parameter provided in the package request 101.

The component products that are identified as available component products are associated with the selected package product (213) and information regarding the selected package product and the associated component products is provided (215). For example, the information regarding the selected package product and the associated component products is provided in the package information 109 to a user that generated the package request 101. In some implementations, two or more package products are selected and available package component products are identified for each. The available component products are associated with appropriate package products and information regarding the two or more package products and their associated available component products is provided.

Additionally, for one or more of the component slots of the selected package products, the package engine 110 can select a primary component product which is used as the default component product for the selected package product. For example, a provider of the package product can select a preferred component product provider, including where the provider of the package product prefers their own component products. Similarly, the primary component can be selected according to an affect on a profitability of the package product, on the price of the package, or based on another parameter. For example, a lowest cost component product can be selected as the primary component for each component slot of the package product. In some implementations, the primary component products can be selected according to one or more of the packaging rules.

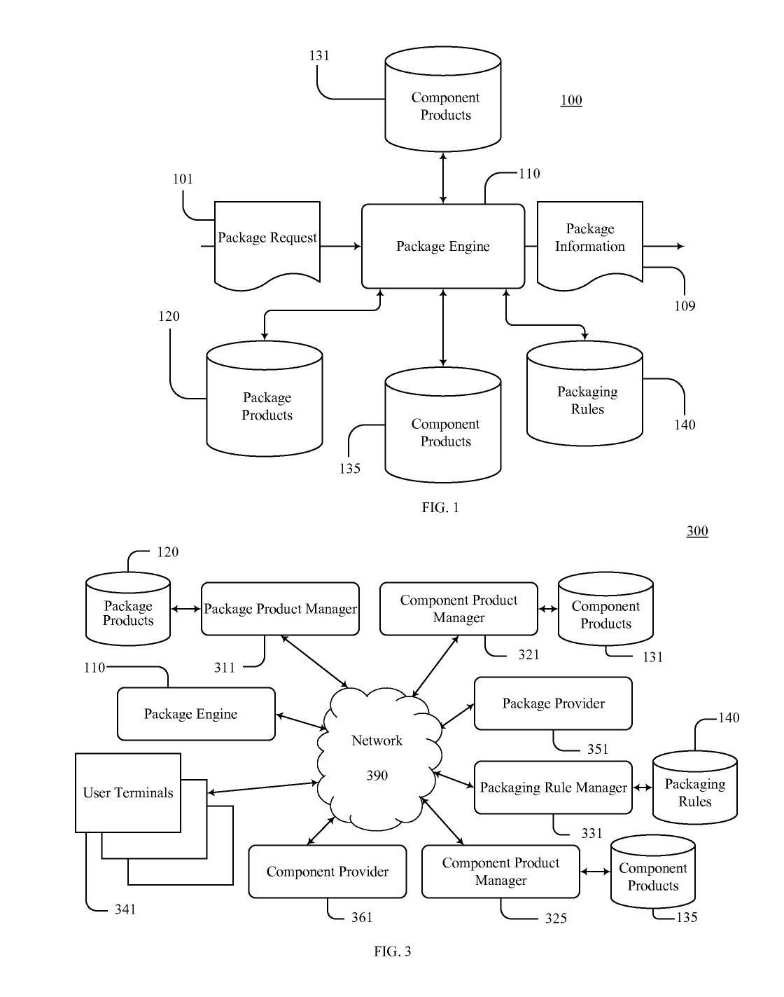

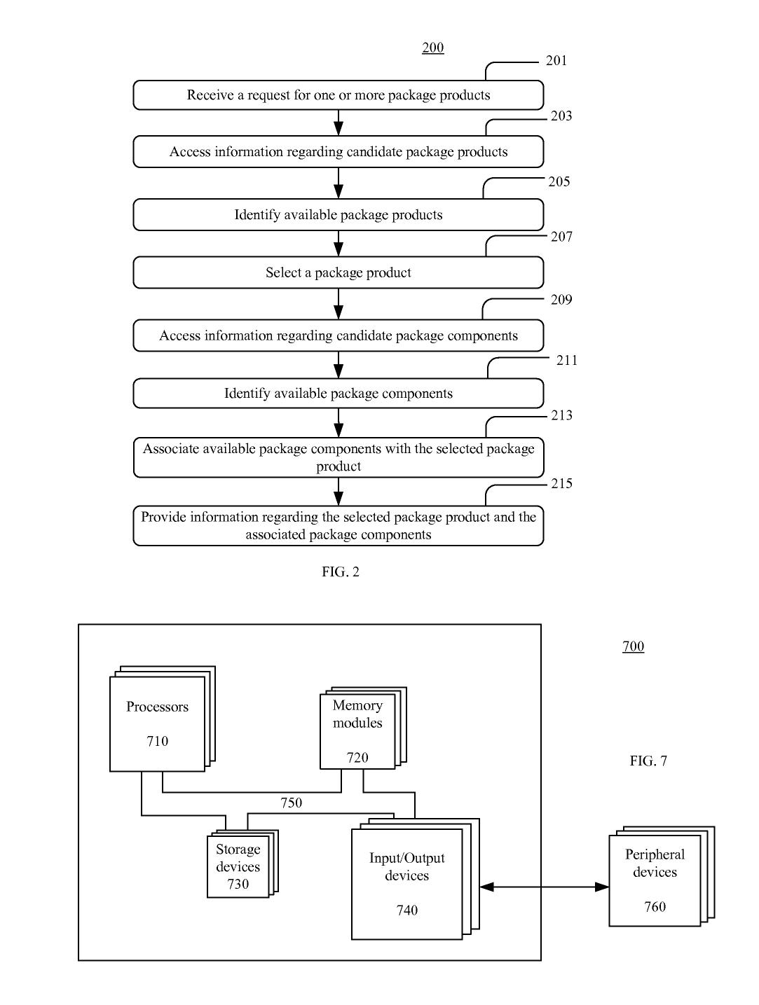

Referring to FIG. 3, the package engine 110 of FIG. 1 can be used in a system 300 to provide travel package products to customers, including resellers such as travel agents. In addition to the package engine 110, the system 300 includes a package product manager 311 that is operable to manage information regarding the package products that is stored in the package product information repository 120. For example, the package product manager 311 can add, remove, and/or modify information regarding one or more package products stored in the package product information repository 120 and can selectively grant or deny access to the package product information repository 120. Similarly, component product managers 321 and 325 are operable to manage information stored in the component product information repositories 131 and 135, respectively. Also, a packaging rule manager 331 is operable to manage information regarding one or more packaging rules stored in the packaging rule information repository 140. The system 300 also includes user terminals 341, one or more package product providers 351, one or more component product providers 361, and a network 390 that connects one or more components of the system 300.

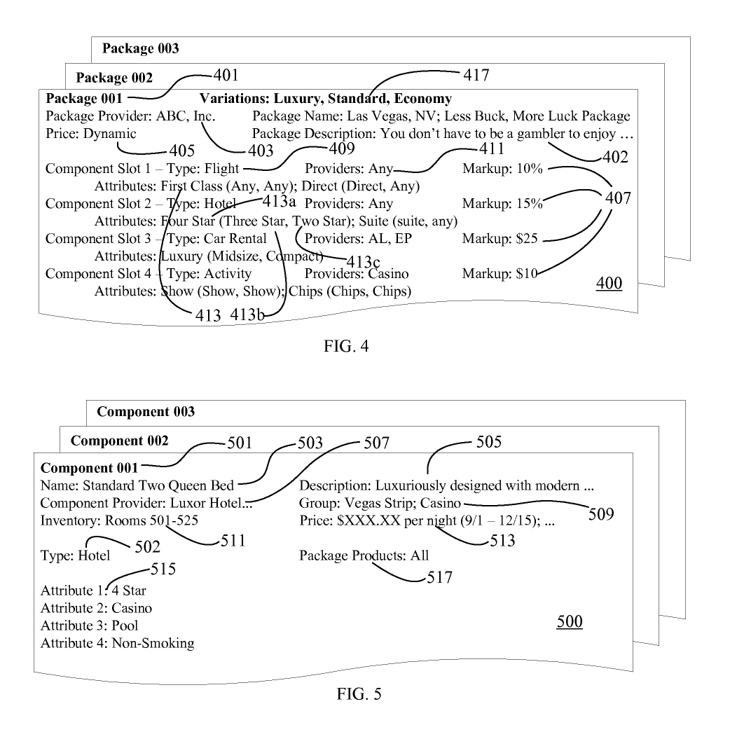

In some implementations, the package product information stored in the package product information repository 120 can be stored in a data structure, such as the data structure 400 illustrated in FIG. 4. The data structure 400 includes a package product identifier 401, information regarding a name and description of the package 402, and information regarding a provider of the package 403. The data structure 400 also includes pricing information for the package product 405. For example, package products include a fixed pricing option or a dynamic pricing option. If the fixed pricing option is selected, information regarding a selected price of the package product is included in the data structure 400. If, as illustrated, the dynamic pricing option is selected, an indication of dynamic pricing is included in the data structure. The pricing information 405 allows the package engine 110, or another system or component, to provide price information to a customer. For example, if the fixed pricing option is selected, the selected price is indicated to the customer as the price of the package product. If the dynamic pricing option is selected, the package engine 110 can generate a price for the package product based on prices of the component products based on markup information 407 that is used to generate a price for the package product based on the prices of the component products. The markup information 407 can be flat markup information, where a dollar amount of the markup is indicated, or dependent markup information, where a percentage amount of the markup is indicated. If the fixed pricing option is selected, the markup information 407 is not included, and information regarding maximum allowed prices for the component products is included in its place.

The data structure 400 also includes, for each component slot of the package product, component product type information 409, component product provider information 411, and component product attribute information 413. The component product type information 409 defines what type or types of component products match the component slot of the package product. The component product type information 409 can be selected from a predetermined group of component product types. The component product provider information 411 can identify specific approved providers whose component products can be selected to fill the slot, or can identify categories of component product providers whose component products can be selected to fill the slot. As illustrated, the package 001 includes a first component slot for an airline flight that can be filled by airline flights from any provider. The price of the airline flight will be marked-up by ten percent. A second slot of the package 001 is for a hotel room that can be filled by any provider and whose price will be marked-up by fifteen percent. The third component slot is for a rental car, can only be filled by rental cars from Alamo or Enterprise, and the price of the rental car will be marked up by twenty-five dollars. The package 001 also includes a fourth slot for an activity component. The component product provider information 411 for the fourth component slot indicates that activity component can be provided by any provider that is a member of a group of casinos.

The data structure 400 also includes component product attribute information 413 for each component slot. The component product attribute information 413 defines features that a component product must have or exceed in order to fill the component slot. For example, the first component slot for an airline flight includes component attribute information 413 that indicates that a first class feature is required for a component product to fill the first component slot. Thus, any airline flights that do not have an available first class seat are not identified as available component products for the package 001. Additionally, the data structure 400 can include package variation information 417 regarding different package alternatives. For example, the package 001 includes information regarding a luxury variation, a standard variation, and an economy variation. One or more of the other pieces of information included in the data structure 400 can include alternatives associated with the variations. For example, the package 001 includes component product attribute information 413a-413c for each of the three variations. As illustrated, the component product attribute information 413a for the second slot for the hotel room indicates that, for the luxury variation, a hotel room component product must be a four or five star hotel. The component product attribute information 413b for the second slot for the hotel room indicates that, for the standard variation, a hotel room component product must be a three, four, or five star hotel. The component product attribute information 413c for the second slot for the hotel room indicates that, for the economy variation, a hotel room component product must be a two, three, four, or five star hotel. Similarly, different markup information 407, different component product provider information 411, and/or different package name description information 402 for one or more of the different variations.

Now referring to FIG. 5, the component product information stored in the component product information repositories 131 and/or 135 can be stored in a data structure 500. The data structure 500 includes general information regarding the component product, including component product identification information 501, component product type information 502, component product name information 503, component product description information 505, and component product provider information 507. The data structure 500 also includes component product provider group information 509 that indicates which provider groups include the component product provider. Address information, contact information, customer rating information, and/or other information regarding the component product and/or the component product provider can also be included in the data structure 500.

In addition to the general information, the data structure 500 includes inventory information 511 regarding which products of the component provider product are suitable products for the component product, and price information 513 for the component product. For example, the inventory information 511 indicates which rooms of the hotel match the name information 503, the description information 505, and/or attribute information 515, such that the rooms are suitable component products. The price information 513 indicates a price for the component product that is required by the component product provider. The inventory information 511 and/or the price information 513 can be a fixed value such that it does not vary depending on any other parameters, or can be a dependent value. For example, the price information 513 can vary depending on a booking date or reservation dates for the rooms, such as to account for seasonal rate changes, surcharges for special events, or for other considerations.

The attribute information 515 includes information regarding each attribute that is satisfied by the inventory associated with the component product. For example, each of the rooms indicated by the inventory information 511 is in a hotel that has a 4 star rating, has a casino, and has a pool. Also, each of the rooms is a non-smoking room. Although not shown, the data structure 500 can include other attribute information 515, such as information regarding whether the room is a suite, bed size, room view, available services, or other feature of the hotel or the individual rooms associated with the component product. The attribute information 515 can be used to determine whether the component product satisfies required criteria for a given package product. Additionally, the data structure 500 can include package product exclusion information 517 that indicates criteria that must be satisfied by a package product in order for the component product to be eligible to fill a component slot of the package product. For example, a component product provider can select only desired partner package product providers for which the component product is available to fill a component slot. Similarly, the package product exclusion information 517 can include information regarding other component product types that must be included in a package product, minimum package product price information, maximum component product markup information, and/or other package product or package product provider criteria that must be satisfied for the component product to be available to fill a component slot of a package product.

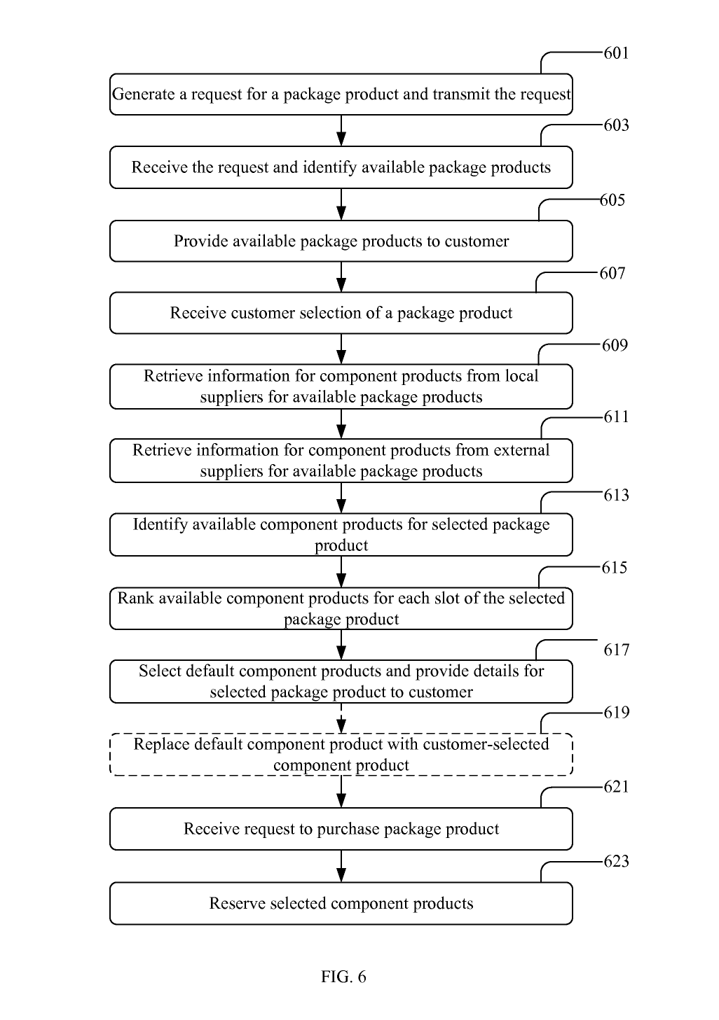

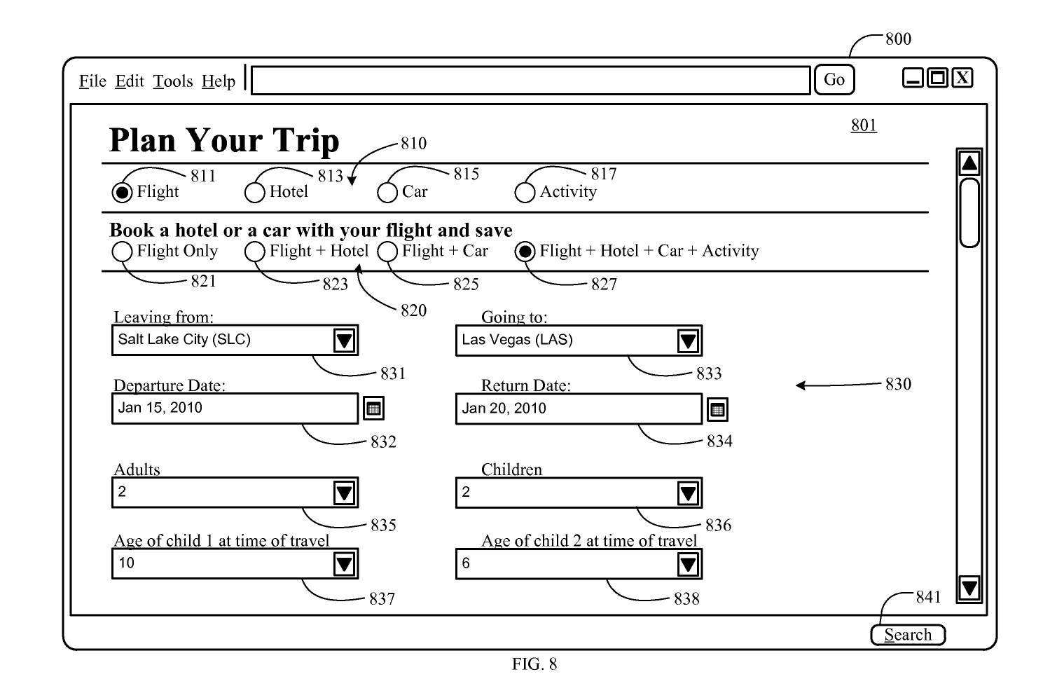

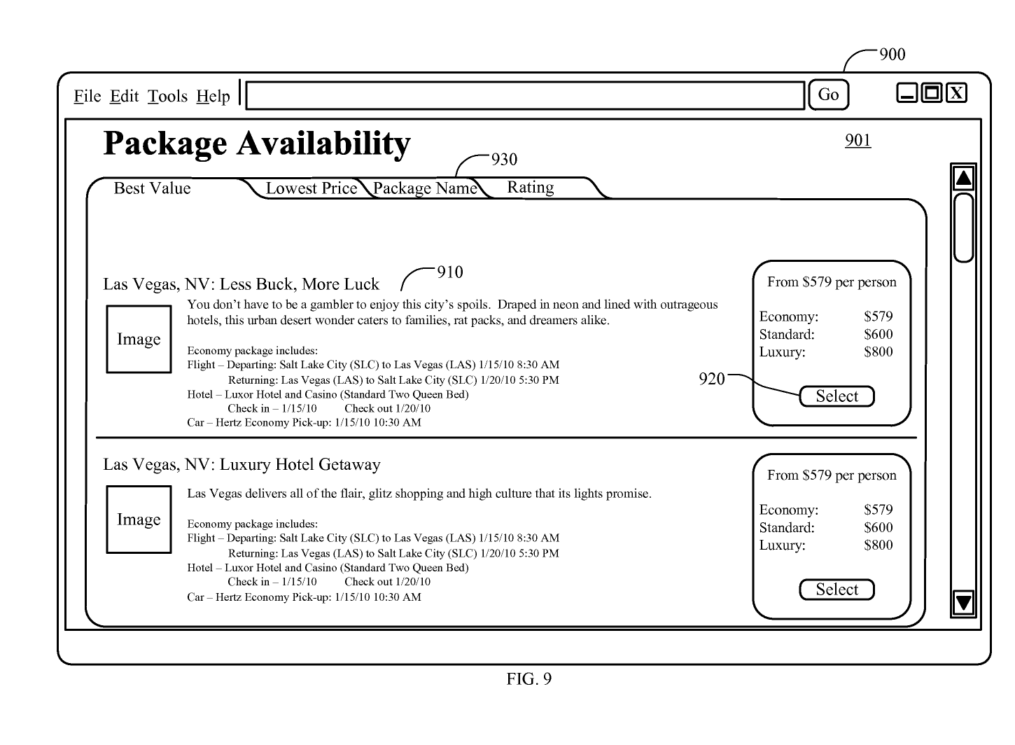

In use, the system 300 can be used to provide information regarding travel package products according to a process 600, illustrated in FIG. 6. Initially, a customer uses one of the user terminals 341 to generate a request for a package product and transmits the request to the package engine 110 (601). For example, the user can select component products, such as an airline flight, a hotel room, a rental car, and an activity, that the consumer wants to be included in the package product using a user interface, such as the user interface 800 shown in FIG. 8. The package engine 110 receives the request from the user terminal and identifies available package products (603) that include slots for the selected component products included in the request. For example, the package engine 110 can identify package products that include a slot for an airline flight, a slot for a hotel room, a slot for a rental car, and a slot for an activity. The package engine 110 provides the available package products to the customer for review and selection (605). For example, information regarding the available package products can be displayed in a user interface, such as the user interface 900 of FIG. 9.

After reviewing the available package products, the customer can select a package product and transmit information regarding the selection to the package engine 110. The package engine 110 receives the information regarding the selection (607) and retrieves information regarding candidate component products for the component product types included in the selected package product from local suppliers (609) and from external suppliers (611). For example, if the package product provider offers airline flights, then the package engine 110 retrieves information regarding candidate airline flights from the package provider and retrieves information regarding candidate hotel rooms, rental cars, and activities from providers of these component products. The package engine 110 then identifies available component products from among the retrieved candidate component products for the selected package product (613). For example, the package engine 110 retrieves one or more packaging rules associated with the selected package product and determines whether each component product is available for the selected package product according to the rules.

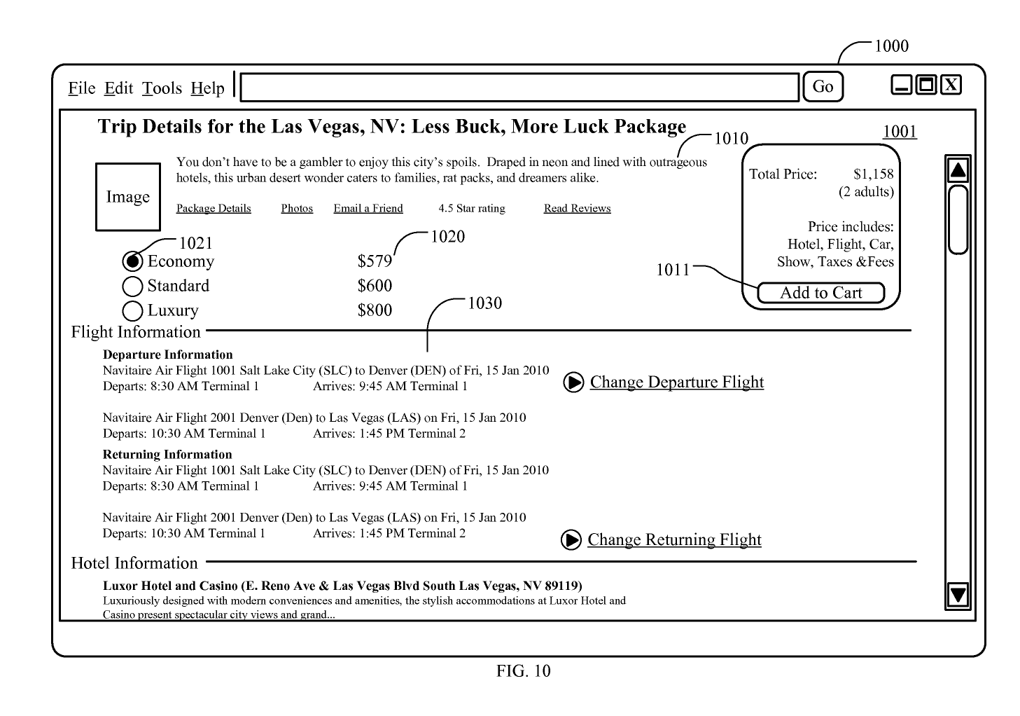

The package engine 110 also ranks the available component products for the selected available package product (615) and selects a default component product for each slot of the selected package product. Information regarding the default component products is provided to the customer (617). For example, the available component products can be ranked according to the retrieved rules and one airline flight, one hotel room, one rental car, and one activity can be selected as default component products. Information regarding the selected default component products can be provided to the customer using a user interface, such as the user interface 1000 of FIG. 10. In some implementations, the component products that yield the lowest price or the greatest profit can be selected as the default component products. In some implementations, component products associated with preferred partner providers can be selected as the default products.

If the customer wants to obtain information about other available component products for a selected component slot, the user can request the additional information using a user interface. In response to receiving the request for information about other available component products, the package engine 110 can display information regarding the other available component products, and allow the customer to select an alternative component product. If a different component product is selected by the customer, the package engine 110 replaces the default component product, or a previously-selected component, with the component product selected by the customer (619).

When the customer has completed any and all desired changes, the customer can purchase the package product including the default or selected component products using the user interface 1000. In response to receiving a request to purchase the package product (621), the package engine 110 reserves each of the default or selected component products (623). For example, the package engine 110 can transmit an indication of the purchase to each of the suppliers of the component products such that inventory items can be reserved or marked as sold or otherwise unavailable.

Referring to FIG. 7, the package engine model 110 and/or components thereof, and/or one or more other components of the systems 100 and 300 can include one or more computer systems, such as the computer system 700, or components thereof. The computer system 700 includes one or more processors 710, memory modules 720, storage devices 730, and input-output devices 740 connected by a system bus 750. The input-output devices 740 are operable with one or more peripheral devices 760, including a communication device that is operable to communicate with other computer systems or components thereof. Other peripheral device that may be included in the computer system 700 include output devices such as displays, speakers, and printers, and input devices such as pointers, microphones, keyboards, and scanners. The one or more computer systems 700 can perform the various functions described in this disclosure by executing computer instructions embodied in computer software stored on a computer-readable storage device, such as the memory modules 720, the storage devices 730, and/or the peripheral devices 760.

Now referring to FIG. 8, the user interface 800 includes a display area 801 and selection controls 810. For example, the customer can select a button 811 associated with an airline flight, a button 813 associated with a hotel room, a button 815 associated with a rental car, or a button 817 associated with an activity. After selecting the button 811, for example, selection controls 820 are presented to the customer. The selection controls 820 include a button 821 for airline flights only, a button 823 for packages including a flight and a hotel room, a button 825 for packages including a flight and a rental car, and a button 827 for packages including a flight, a hotel room, a rental car, and an activity. After selecting the button 827, for example, selection controls 830 are presented to the customer. The selection controls 830 include an input field 831 for selecting a departure location, an input field 832 for selecting a departure date, an input field 833 for selecting a destination location, and an input field 834 for selecting a return date. The selection controls 830 also include an input field 835 for selecting a number of adult travelers, an input field 836 for selecting a number of child travelers, an input field 837 for selecting an age of a first child traveler, and an input field 838 for selecting an age of a second child traveler. The user interface 800 can also include other selection controls to allow the customer to input other desired or required information. After inputting information using the selection controls, the customer can select a search control 841 to submit a search request to the package engine 110 for available packages that include component slots for the selected component products and that meet the availability criteria based on the information provided by the customer.

As discussed above, in response to receiving the search request, the package engine 110 provides information regarding available package products by presenting the user interface 900 of FIG. 9. The user interface 900 includes a display area 901 where information regarding one or more available package products is presented to the customer. For example, for each available package product, information 910 regarding the name, description, package provider, price, default components, and/or package variations can be displayed. The user interface 900 also includes a selection control button 920 for selecting an associated package product. Optionally, the information regarding the available package products is sorted according to one of various criteria, and can be resorted using sorting controls 930.

After selecting a selection control button 920, the user interface 1000 of FIG. 10 is displayed to the user. The user interface 1000 includes a display area 1001 for displaying information regarding the selected package product 1010, information regarding product package variations 1020, and information regarding component products 1030. The display area 1001 includes a selection control 1011 that is operable to purchase the package product with the current component product selections, selection controls 1021 that are operable to select variations of the package product, and selection controls 1031 that are operable to select different component products.

While some implementations are described above, these should not be viewed as exhaustive or limiting, but rather should be viewed as exemplary, and are included to provide descriptions of various features. It will be understood that various modifications may be made. For example, the steps of the described exemplary processes can be performed by one or more different entities, systems, and or system components. Similarly, other components that are described as separate can be combined, and components can include multiple separate sub-components. With regard to the processes described above, the steps of the described processes can be performed in any order that achieves the described results.

A number of implementations have been described. Nevertheless, it will be understood that various modifications may be made without departing from the spirit and scope of the disclosure. Accordingly, other implementations are within the scope of the following claims.

1. A method for providing package products, comprising:
receiving a request for one or more package products, the one or more package products including package components, the request including information regarding types of package components to be included in the one or more package products and availability information;
accessing information regarding candidate package products, each candidate package product including package slots for a type of package component;
identifying, by at least one computer processor, available package products from among the candidate package products based on the package products having package component slots for package components of the types included in the request;
selecting a package product from among the identified package products;
accessing information regarding candidate package components;
identifying, by at least one computer processor, available package components from among the candidate package components, the available package components having package component types that match the package component types of the package component slots of the selected package product and having availability information compatible with the availability information of the request;
associating the available package components with the identified package products, the available package components being associated with the identified package products based on a match between the package component types of the available package components and the selected package product; and
providing information regarding the selected package product and the available package components in response to the request for a package product.

2. The method of claim 1, wherein the types of package components to be include in the product package includes at least one of an airline flight, a hotel room, a rental car, an activity, an insurance product, and a retail product.

3. The method of claim 1, wherein the package components include price information.

4. The method of claim 3, wherein the selected package product comprises pricing information regarding how a price of an available package product is to be generated based on the price information of the package components associated with the candidate package product.

5. The method of claim 4, wherein the pricing information includes at least one of fixed pricing information and dependent pricing information, the fixed pricing information being used to select available package components to be associated with the candidate package product and the dependent pricing information being used to adjust the price information of the available package products associated with the candidate package product.

6. The method of claim 1, wherein the available package components are associated with the identified package products based on package generation rules associated with the available package products.

7. The method of claim 1, wherein two or more of the available package products are selected and information regarding the two or more selected package products is provided in an order determined according to one or more ranking rules that are applied to each of the available package products.

8. A system comprising:
a receiver that receives a request for one or more package products, the one or more package products including package components, the request including information regarding types of package components to be included in the one or more package products and availability information;
one or more storage devices that store information regarding candidate package products, each candidate package product including package slots for a type of package component; and one or more computer processors that:
identify available package products from among the candidate package products based on the package products having package component slots for package components of the types included in the request,
select a package product from among the identified package products,
identify available package components, the available package components having package component types that match the package component types of the package component slots of the selected package product and having availability information compatible with the availability information of the request, and
associate the available package components with the selected package product, the available package components being associated with the identified package products based on a match between the package component types of the available package components and the selected package product.

9. The system of claim 8, wherein the types of package components to be include in the product package includes at least one of an airline flight, a hotel room, a rental car, an activity, an insurance product, and a retail product.

10. The system of claim 8, wherein the package components include price information.

11. The system of claim 10, wherein the selected package product comprises pricing information regarding how a price of an available package product is to be generated based on the price information of the package components associated with the candidate package product.

12. The system of claim 11, wherein the pricing information includes at least one of fixed pricing information and dependent pricing information, the fixed pricing information being used to select available package components to be associated with the candidate package product and the dependent pricing information being used to adjust the price information of the available package products associated with the candidate package product.

13. The system of claim 8, wherein the available package components are associated with the identified package products based on package generation rules associated with the available package products.

14. The system of claim 8, wherein two or more of the available package products are selected and information regarding the two or more selected package products is provided in an order determined according to one or more ranking rules that are applied to each of the available package products.

15. A tangible computer-readable storage medium having a computer program product stored thereon, the computer program product including instructions that, when executed by one or more computer processors, enable:
receiving a request for one or more package products, the one or more package products including package components, the request including information regarding types of package components to be included in the one or more package products and availability information;
accessing information regarding candidate package products, each candidate package product including package slots for a type of package component;
identifying, by at least one computer processor, available package products from among the candidate package products based on the package products having package component slots for package components of the types included in the request;
selecting a package product from among the identified package products;
accessing information regarding candidate package components;
identifying, by at least one computer processor, available package components from among the candidate package components, the available package components having package component types that match the package component types of the package component slots of the selected package product and having availability information compatible with the availability information of the request;
associating the available package components with the identified package products, the available package components being associated with the identified package products based on a match between the package component types of the available package components and the selected package product; and
providing information regarding the selected package product and the available package components in response to the request for a package product.

16. The tangible computer-readable storage medium of claim 15, wherein the types of package components to be include in the product package includes at least one of an airline flight, a hotel room, a rental car, an activity, an insurance product, and a retail product.

17. The tangible computer-readable storage medium of claim 15, wherein the package components include price information.

18. The tangible computer-readable storage medium of claim 17, wherein the selected package product comprises pricing information regarding how a price of an available package product is to be generated based on the price information of the package components associated with the candidate package product.

19. The tangible computer-readable storage medium of claim 18, wherein the pricing information includes at least one of fixed pricing information and dependent pricing information, the fixed pricing information being used to select available package components to be associated with the candidate package product and the dependent pricing information being used to adjust the price information of the available package products associated with the candidate package product.

20. The tangible computer-readable storage medium of claim 19, wherein the available package components are associated with the identified package products based on package generation rules associated with the available package products.

21. The tangible computer-readable storage medium of claim 15, wherein two or more of the available package products are selected and information regarding the selected package products is provided in an order determined according to one or more ranking rules that are applied to each of the available package products.
